(19) United States
(12) Patent Application Publication
(10) Pub. No.: US 2024/0265810 A1
(43) Pub. Date: Aug. 8, 2024

(54) INFORMATION PROCESSING SYSTEM

(71) Applicant: TOYOTA JIDOSHA KABUSHIKI KAISHA, Toyota-shi (JP)

(72) Inventor: Satoshi UNO, Mishima-shi (JP)

(73) Assignee: TOYOTA JIDOSHA KABUSHIKI KAISHA, Toyota-shi (JP)

(21) Appl. No.: 18/507,278

(22) Filed: Nov. 13, 2023

(30) Foreign Application Priority Data
Feb. 6, 2023 (JP) 2023-016086

(51) Int. Cl. G08G 1/16; G08G 1/01

(52) U.S. Cl. CPC G08G 1/163; G08G 1/0112; G08G 1/0133; G08G 1/0141

(57) ABSTRACT

An information processing system for estimating whether the activation of a collision warning in a predetermined target vehicle is reproduced in another target vehicle, comprising: an acquisition unit for acquiring target vehicle data, which is information about the target vehicle; and a target of the predetermined target vehicle. By inputting the target vehicle data acquired by the acquisition unit into the collision warning reproduction model generated by extracting the feature amount that contributes to the reproduction of the collision warning from the vehicle data, it is possible to determine whether the collision warning will be reproduced in other target vehicles and a reproduction estimation unit for estimating.

### CROSS-REFERENCE TO RELATED APPLICATION

This application claims priority to Japanese Patent Application No. 2023-016086 filed on Feb. 6, 2023, incorporated herein by reference in its entirety.

### BACKGROUND

### 1. Technical Field

The present disclosure relates to an information processing system.

### 2. Description of Related Art

Japanese Unexamined Patent Application Publication No. 2020-052607 (JP 2020-052607 A) discloses an information processing system that acquires position information when unstable behavior such as a slip has occurred in a target vehicle, and sequentially collects the acquired position information in a server in association with information on the cause of the unstable behavior.

### SUMMARY

It is assumed that an artificial intelligence (AI) model generated by machine learning is used to estimate whether a collision warning that has been activated in a predetermined target vehicle can be reproduced in other target vehicles, and the other target vehicles are cautioned based on an estimation result. If the accuracy of the estimation of the reproduction of the collision warning is low, the other target vehicles are cautioned unnecessarily. That is, there is a problem that drivers are annoyed. Therefore, it is desirable to improve the accuracy of the estimation of the reproduction of the collision warning by generating the AI model using a feature amount that contributes greatly to the reproduction of the collision warning.

An object of the technology of the present disclosure is to effectively improve the accuracy of the estimation of the reproduction of the collision warning.

The present disclosure provides an information processing system configured to estimate whether activation of a collision warning in a predetermined target vehicle is reproducible in another target vehicle. The information processing system includes:
an acquisition unit configured to acquire target vehicle data that is information on the target vehicle; and
a reproduction estimation unit configured to estimate whether the collision warning is reproducible in the other target vehicle by inputting the target vehicle data acquired by the acquisition unit to a collision warning reproduction model generated by extracting a predetermined feature amount that contributes to reproduction of the collision warning from the target vehicle data of the predetermined target vehicle.

### BRIEF DESCRIPTION OF THE DRAWINGS

Features, advantages, and technical and industrial significance of exemplary embodiments of the present disclosure will be described below with reference to the accompanying drawings, in which like signs denote like elements, and wherein:

FIG. 1A is a schematic diagram illustrating an information processing system of the present disclosure;

FIG. 1B is a schematic diagram illustrating the information processing system of the present disclosure;

FIG. 2 is a schematic diagram illustrating a target vehicle of the present disclosure;

FIG. 3 is a schematic diagram illustrating an information processing server of the present disclosure;

FIG. 4 is a schematic diagram illustrating an example of meshes set on the map of the present disclosure;

FIG. 5 is a diagram for explaining feature amounts according to types of warning target objects of the present disclosure;

FIG. 6A is a flowchart illustrating routines for various processes of the present disclosure; and

FIG. 6B is a flowchart describing routines for various processes of the present disclosure.

### DETAILED DESCRIPTION OF EMBODIMENTS

An information processing system according to the present embodiment will be described below with reference to the drawings.

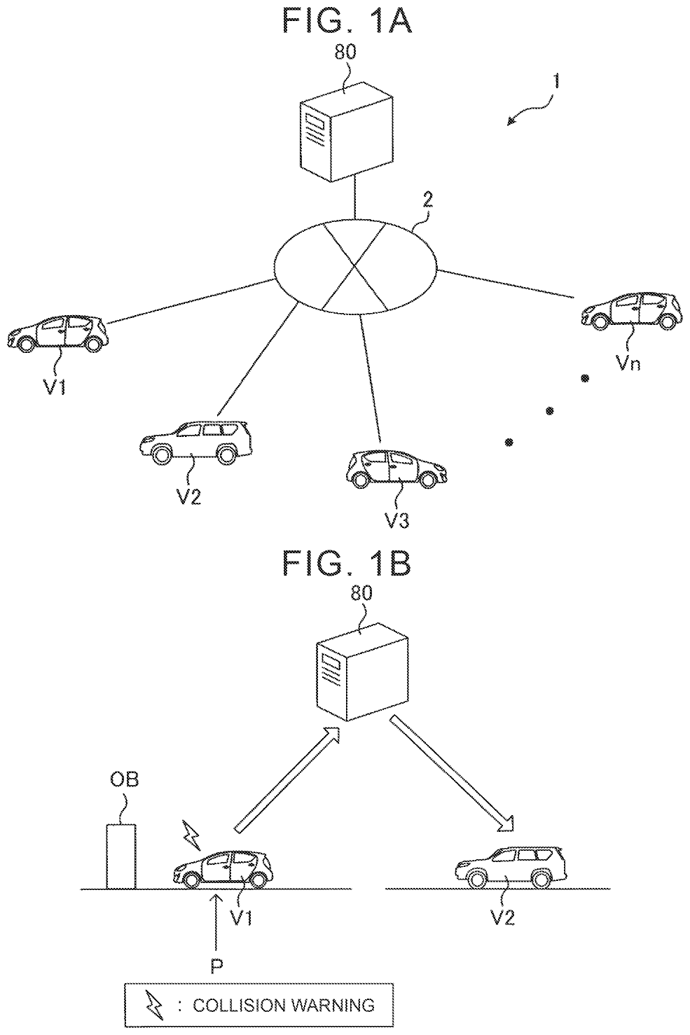

As shown in FIG. 1A, the information processing system 1 includes a plurality of target vehicles V1 to Vn and an information processing server 80. The plurality of target vehicles V1 to Vn and the information processing server 80 are communicably connected to each other via the network 2. Network 2 is, for example, a wireless communication network.

The target vehicles V1 to Vn are vehicles from which the information processing server 80 collects information. The target vehicles V1 to Vn do not need to be vehicles of the same configuration, and may be vehicles equipped with at least a collision warning function. Collision warning is a concept that includes rear-end collision warning. The target vehicles V1 to Vn also include support target vehicles for which support control such as alerting is performed by the information processing server 80. Below, the multiple target vehicles V1 to Vn are also simply referred to as “target vehicles V”.

The information processing server 80 is, for example, a server device installed in a management company's cloud computing system, data management center, or the like. Based on the information collected from the target vehicle V, the information processing server 80 estimates whether the collision warning will be reproduced. Then, the information processing server 80 performs support control such as calling attention to the target vehicle V based on the estimation result. FIG. 1B is a schematic diagram illustrating an example of the flow of information processing. As shown in FIG. 1B, it is assumed that a collision warning is activated in the target vehicle V1 as the target vehicle V1 abnormally approaches an obstacle OB or the like. In this case, the target vehicle V1 transmits to the information processing server 80 information including the warning activation position P, which is the position at which the collision warning is activated. For example, when another target vehicle V2 traveling behind the target vehicle V1 approaches the warning activation position P, the information processing server 80 estimates whether the collision warning will be reproduced in the target vehicle V2. When the information processing server 80 estimates that the collision warning will be reproduced in the target vehicle V2, the information processing server 80 executes support control such as calling attention to the target vehicle V2. This makes it possible to effectively suppress the occurrence of a collision at the warning activation position P of the target vehicle V2.

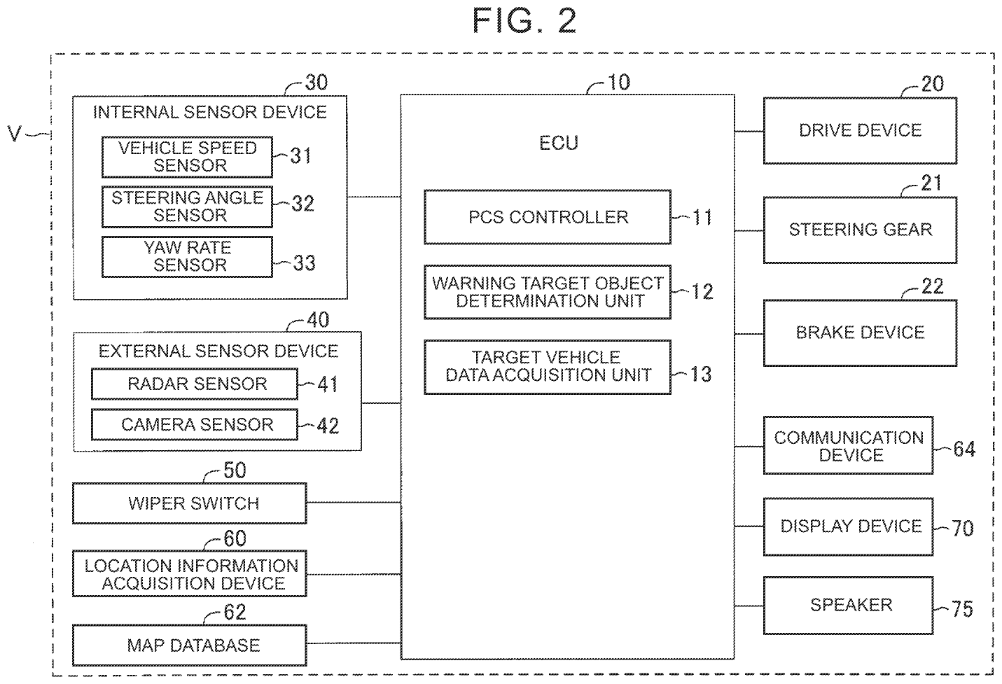

FIG. 2 is a schematic diagram showing the hardware configuration and software configuration of the target vehicle V. An identification number (vehicle ID) for identifying the target vehicle V is assigned to the target vehicle V. The target vehicle V has an Electronic Control Unit (ECU) 10. The ECU 10 includes a Central Processing Unit (CPU), Read Only Memory (ROM), Random Access Memory (RAM), and the like. The CPU is a processor that executes various programs stored in the ROM. ROM is non-volatile memory.

The ROM stores data and the like necessary for the CPU to execute various programs. RAM is volatile memory. The RAM provides a working area in which various programs are expanded when executed by the CPU.

The ECU 10 is a central device that performs various controls on the target vehicle V, such as a collision warning. Therefore, the ECU 10 is connected to various devices 20, 21, 22, 30, 40, 50, 60, 62, 64, 70, 75, and the like.

The driving device 20 generates a driving force to be transmitted to the driving wheels of the target vehicle V. The steering device 21 applies a steering force to the wheels of the target vehicle V. The braking device 22 applies braking force to the wheels of the target vehicle V.

The internal sensor device 30 is sensors that detect the state of the target vehicle V. Specifically, the internal sensor device 30 includes a vehicle speed sensor 31, a steering angle sensor 32, a yaw rate sensor 33, and the like. The vehicle speed sensor 31 detects the traveling speed of the target vehicle V (vehicle speed v). The steering angle sensor 32 detects the steering angle of the target vehicle V. The yaw rate sensor 33 detects the yaw rate of the target vehicle V. The internal sensor device 30 transmits the states of the target vehicle V detected by the sensors 31 to 33 to the ECU 10 at predetermined intervals.

The external sensor device 40 is a sensor that recognizes target object information about targets around the target vehicle V. Specifically, the external sensor device 40 includes a radar sensor 41, a camera sensor 42, and the like. Examples of target information include surrounding vehicles, pedestrians, structures such as sidewalls and guardrails, traffic lights, white lines on roads, signs, and fallen objects.

The radar sensor 41 detects a target existing in a front area of the target vehicle V. The radar sensor 41 includes millimeter wave radar and/or lidar. The millimeter wave radar radiates radio waves (millimeter waves) in the millimeter wave band and receives millimeter waves (reflected waves) reflected by targets existing within the radiation range. Based on the phase difference between the transmitted millimeter wave and the received reflected wave, the attenuation level of the reflected wave, the time from transmitting the millimeter wave to receiving the reflected wave, etc., the millimeter wave radar detects the target vehicle V and The relative distance to the target, the relative speed between the target vehicle V and the target, and the like are acquired. The lidar sequentially scans a plurality of directions with pulsed laser light having a wavelength shorter than a millimeter wave, and receives reflected light reflected by a target. Thereby, the rider acquires the shape of the target detected in front of the target vehicle V, the relative distance between the target vehicle V and the target, the relative speed between the target vehicle V and the target, and the like.

The camera sensor 42 is, for example, a stereo camera or a monocular camera, and a digital camera having an imaging device such as CMOS or CCD can be used. The camera sensor 42 captures an image of the front of the target vehicle V and processes the captured image data. Thereby, the camera sensor 42 acquires target object information in front of the target vehicle V. The target information is information representing the type of target detected in front of the target vehicle V, the relative distance between the target vehicle V and the target, the relative speed between the target vehicle V and the target, and the like. The type of target may be recognized by machine learning such as pattern matching, for example.

The external sensor device 40 repeatedly transmits the acquired target object information to the ECU 10 each time a predetermined time elapses. Note that the external sensor device 40 does not necessarily have to include both the radar sensor 41 and the camera sensor 42. For example, the external sensor device 40 may have only the camera sensor 42.

A wiper switch 50 is a switch for operating a wiper device (not shown). For example, the wiper switch 50 is arranged on the steering column of the target vehicle V. The wiper device is a device for wiping the outer surface of the windshield of the target vehicle V. The wiper switch 50 is configured to be selectively operable, for example, between an OFF position that deactivates the wiper device and an ON position that activates the wiper device. The wiper switch 50 transmits a signal to the ECU 10 according to the operation position. In the following description, a signal transmitted to the ECU 10 when the wiper switch 50 is turned OFF is called a “wiper OFF signal”, and a signal transmitted to the ECU 10 when the wiper switch 50 is turned ON is called a “wiper ON signal”.

The position information acquisition device 60 acquires the current position information of the target vehicle V. As the position information acquisition device 60, for example, a Global Positioning System (GPS) provided in a navigation device can be used. The position information acquisition device 60 transmits the acquired current position information of the target vehicle V to the ECU 10 at predetermined intervals.

The map database 62 is a database of map information, and is stored in a storage device that the target vehicle V has. The map information includes the positions of roads and intersections, the shapes of roads, and the like. Note that the target vehicle V only needs to be able to transmit the position information acquired by the position information acquisition device 60 to the information processing server 80. The target vehicle V may be a vehicle without the map database 62. If the target vehicle V does not have the map database 62, the target vehicle V may use the communication device 64 to acquire map information from an external server (for example, the information processing server 80).

The communication device 64 is a communication device for the target vehicle V to communicate with an external device. The communication device 64 transmits and receives various information via the network 2. The communication device 64 transmits various types of information to the information processing server 80 according to commands from the ECU 10.

The display device 70 is, for example, a multi-information display, a head-up display, a navigation system display, or the like. The display device 70 displays various images according to commands from the ECU 10. The speaker 75 is, for example, a speaker of an acoustic system or a navigation system. A speaker 75 outputs a warning sound or the like according to a command from the ECU 10.

Next, the software configuration of the ECU 10 will be described. The ECU 10 includes a Pre-Crash Safety (PCS) control unit 11, a warning target object determination unit 12, a target vehicle data acquisition unit 13, and the like as functional elements. These functional elements 11 to 13 are realized by the CPU of the ECU 10 reading a program stored in the ROM into the RAM and executing it. Note that the functional elements 11 to 13 can also be provided in another ECU that is separate from the ECU 10. All or part of the functional elements 11 to 13 can also be provided in the information processing server 80.

The PCS control unit 11 issues a collision warning when there is a high possibility that the target vehicle V will collide with a forward target. Based on the target object information transmitted from the external sensor device 40, the PCS control unit 11 acquires coordinate information of an object existing in front of the target vehicle V (hereinafter referred to as a front object). Also, the PCS control unit 11 calculates the trajectory of the target vehicle V based on the detection results of the vehicle speed sensor 31, the steering angle sensor 32 and the yaw rate sensor 33. When the forward object is a moving object, the PCS control unit 11 calculates the trajectory of the moving object based on the coordinate information of the moving object. When the trajectory of the moving object and the trajectory of the target vehicle V intersect, the PCS control unit 11 determines the forward object as the warning target object. Also, when the forward object is a stationary object, the PCS control unit 11 determines the forward object as a warning target object when the track of the target vehicle V intersects the current position of the stationary object.

When the PCS control unit 11 determines that the forward object is a warning target, the PCS control unit 11 determines the target vehicle based on the distance D from the target vehicle V to the warning target and the relative speed vr of the target vehicle V to the warning target. A collision prediction time (Time To Collision: TTC) until V collides with the warning target object is calculated. TTC is an index value indicating the possibility that the target vehicle V will collide with the warning target object. TTC can be obtained by dividing the distance D from the target vehicle V to the warning target object by the relative speed vr (TTC=D/vr). The PCS control unit 11 determines that the possibility of the target vehicle V colliding with the warning target object is high when the TTC is equal to or less than the predetermined determination threshold value Tv. When the PCS control unit 11 determines that there is a high possibility of collision, it turns on the collision warning flag F (F=1). When the collision warning flag F is turned ON, the PCS control unit 11 executes a collision warning by causing the speaker 75 to output a warning sound. Note that the collision warning may be displayed by the display device 70 as well. In addition to issuing a collision warning, the PCS control unit 11 mayalso perform automatic braking or automatic steering to avoid collisions or reduce damage caused by collisions.

The warning target object determination unit 12 determines the type of the warning target when the PCS control unit 11 issues a collision warning. Specifically, the warning target object determination unit 12 determines the type of the warning target by machine learning such as pattern matching based on the image data captured by the camera sensor 42. In this embodiment, the warning target object determination unit 12 determines whether the warning target object is (A) another vehicle (including another target vehicle V), (B) a pedestrian, or (C) a structure such as a side wall or a guardrail. If the warning target object is neither (A) another vehicle, (B) a pedestrian, or (C) a structure, the warning target object determination unit 12 determines that the warning target object is (D) unknown. Note that the types of warning target objects are not limited to (A) to (C), and may include motorcycles, bicycles, utility poles, signs, traffic lights, falling objects, and the like. Further, the warning target object determination unit 12 can be provided in the information processing server 80 by transmitting the image data of the warning target captured by the camera sensor 42 to the information processing server 80 through the communication device 64.

The target vehicle data acquisition unit 13 acquires target vehicle data, which is data relating to the target vehicle V. In this embodiment, the target vehicle data includes (1) vehicle ID, (2) position information (including time), (3) vehicle speed, (4) wiper ON/OFF signal, (5) headlight ON/OFF signal, (6) traffic volume around the current position, (7) ON/OFF of the collision warning flag F, (8) distance D to the warning target object when the collision warning flag F is turned ON, (10) the type of the warning target object ((A) to (D) above). The target vehicle data acquisition unit 13 transmits the acquired target vehicle data to the information processing server 80 through the communication device 64 at predetermined intervals. The target vehicle data may include external environment information around the target vehicle V, such as an outside temperature acquired by an outside temperature sensor (not shown). Further, when the target vehicle V is equipped with a function to identify the driver, the target vehicle data may include driver identification information and the like. Further, when the target vehicle V is equipped with a driver monitor camera or the like, the target vehicle data may include driver status information and the like.

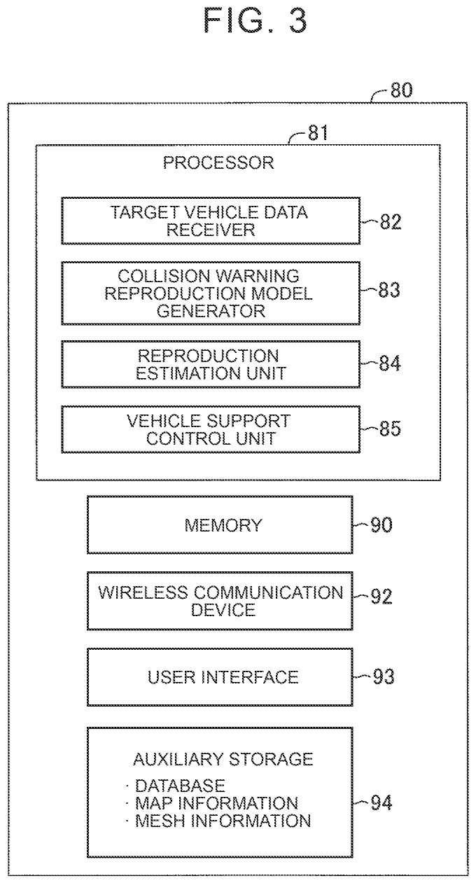

As shown in FIG. 3, the information processing server 80 includes a processor 81 such as a CPU, and a memory 90 such as ROM and RAM. The CPU, ROM, and RAM form a so-called microcomputer. The information processing server 80 also includes a wireless communication device 92, a user interface 93, an auxiliary storage device 94, and the like.

The processor 81 executes various programs stored in the auxiliary storage device 94. For example, the ROM of the memory 90 stores data necessary for the processor 81 to execute various programs. For example, the RAM of the memory 90 provides a work area that is developed when various programs are executed by the processor 81. The wireless communication device 92 is a communication device for wireless communication between the information processing server 80 and the target vehicle V. The user interface 93 is an input device such as a touch panel or keyboard, and an output device such as a display or speaker. The auxiliary storage device 94 is an auxiliary storage device such as an HDD that stores various programs and data used when various programs are executed. A database of the target vehicle V is constructed by storing the target vehicle data transmitted from the target vehicle V via the network N in the auxiliary storage device 94. Map information and mesh information set on the map are stored in advance in the auxiliary storage device 94.

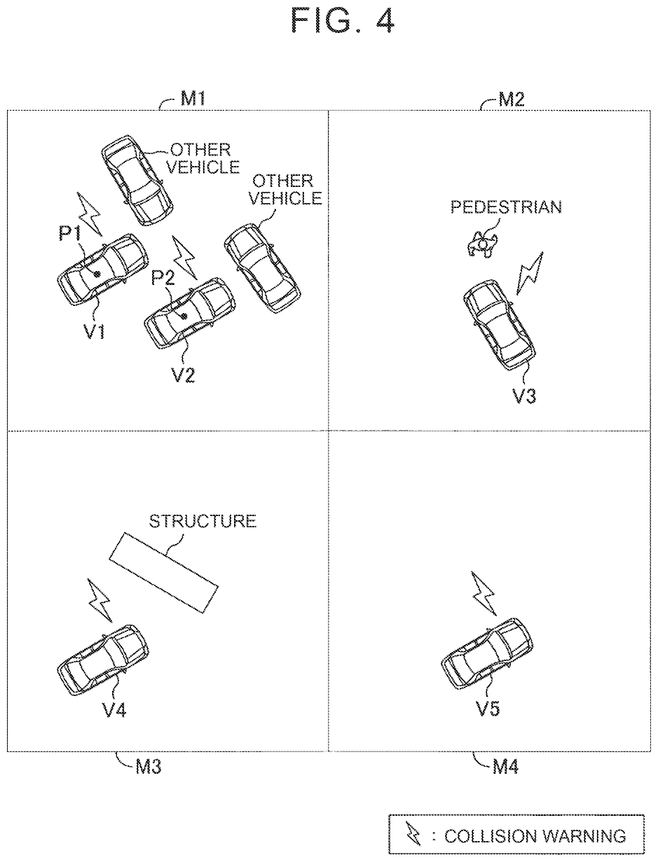

FIG. 4 is a schematic diagram illustrating an example of meshes set on a map. As shown in FIG. 4, the mesh M includes a plurality of meshes M1 to M4. The meshes M1 to M4 are set as, for example, 500-meter square areas on the map. Each mesh M1 to M4 is given a mesh code for identifying the mesh. The number of meshes M is not limited to four in the illustrated example, and may be five or more, 100 or more, or three or less. The size of the mesh M is also not particularly limited, and may be a variable value that is reduced or expanded according to the time of day, the frequency of activation of the collision warning, or the like. Also, the shape of the mesh M is not particularly limited, and may be a shape other than a square such as a rectangle, triangle, or circle.

Here, the reason for using the meshes M1 to M4 will be explained. For example, as shown in FIG. 4, assume that collision warnings have been activated for a plurality of target vehicles V1 and V2 within the area of mesh M1. In this case, it is considered that the warning activation positions P1 and P2, which are the positions at which the multiple collision warnings are activated, do not completely coincide with each other and vary to some extent. By using the meshes M1 to M4 in such a case, it is possible to collectively manage a plurality of warning activation positions P1 and P2 activated within a predetermined distance range. Therefore, compared with the case where the warning activation positions P1 and P2 are individually managed, it becomes possible to improve the efficiency of management.

The software configuration of the processor 81 will be described with reference to FIG. 3 again. As shown in FIG. 3, the processor 81 includes a target vehicle data receiving unit 82, a collision warning reproduction model generation unit 83, a reproduction estimation unit 84, a vehicle support control unit 85, etc. as functional elements.

The target vehicle data receiving unit 82 receives target vehicle data sequentially transmitted from the target vehicle V via the network 2. The target vehicle data transmitted from the target vehicle V includes (1) to (10) described above. The target vehicle data may include environmental information about the target vehicle V, driver information, and the like. Further, when the target vehicle V has the map database 62, the target vehicle data may include the type of road on which the target vehicle V is traveling (automobile road, general road, etc.). The target vehicle data receiving unit 82 associates the received target vehicle data with the mesh code and sequentially stores them in the auxiliary storage device 94.

The collision warning reproduction model generation unit 83 generates a collision warning reproduction model for each of the meshes M1 to M4 on-line at a predetermined cycle based on the target vehicle data of the target vehicle V for which the collision warning has been activated. A well-known method for generating an AI model can be used to generate the collision warning reproduction model. The predetermined period is not particularly limited, and may be, for example, a period of 5 minutes, a period of less than 5 minutes, or a period of 5 minutes or longer. Note that the collision warning reproduction model does not necessarily need to be repeatedly generated online at a predetermined cycle, and can be generated off-line in advance. In this case, the reproduction estimation unit 84, which will be described later, may perform collision warning reproduction estimation by inputting target vehicle data into a collision warning reproduction model generated in advance.

In this embodiment, the feature amounts of the collision warning reproduction model include at least the vehicle speed v of the target vehicle V when the collision warning is activated and the distance D from the target vehicle V to the warning target object when the collision warning is activated. Here, if the vehicle speed v and the distance D are used as the feature amounts of the collision warning reproduction model, it is possible to estimate whether the collision warning will be reproduced. However, it is considered that the feature amount that influences the likelihood of reproduction of the collision warning differs depending on the type of the warning target object (another vehicle, pedestrian, structure, etc.). That is, in order to improve the accuracy of estimating collision warning reproduction, it is desirable to use an optimum feature amount according to the type of the warning target object, specifically, a feature amount that contributes greatly to the estimation result.

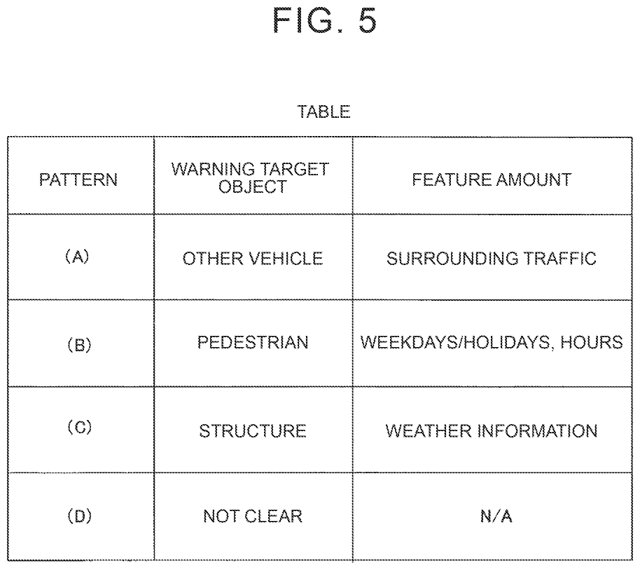

The collision warning reproduction model generation unit 83 extracts a feature amount according to the type of the warning target object from the target vehicle data of the target vehicle V for which the collision warning has been activated. The table in FIG. 5 shows the feature amounts extracted from the target vehicle data by the collision warning reproduction model generation unit 83 for each type of warning target object. Note that the feature amount corresponding to the type of warning target object shown in FIG. 5 maybe set as a default in advance, or the degree of contribution to the estimation result may be calculated, and the feature amount having a large degree of contribution may be selected. A method for calculating the degree of contribution is not particularly limited, and for example, known calculation methods such as Local Interpretable Model-Agnostic Explanations (LIME) and SHapley Additive exPlanations (SHAP) can be used.

Pattern A shown in FIG. 5 is a case where the type of the warning target object is “another vehicle (including another target vehicle V)”, and in the example shown in FIG. 4, mesh M1 corresponds. When the PCS collision warning is activated with “another vehicle” as the warning target object, one of the factors is presumed to be the heavy traffic volume around the target vehicles V1 and V2. In this case, the collision warning reproduction model generation unit 83 employs the “surrounding traffic volume” of the target vehicles V1 and V2 when the collision warning is activated as the feature amount that affects the reproduction of the collision warning. That is, when the type of the warning target object is “another vehicle”, the collision warning reproduction model generation unit 83 generates a collision warning reproduction model using the “surrounding traffic volume” as a feature amount in addition to the vehicle speed v and the distance D. Generate. In this way, when the warning target object is “another vehicle,” the highly correlated “surrounding traffic volume” is used as a feature amount to generate a collision warning reproduction model, thereby reliably improving the accuracy of the reproduction estimation described later. Note that the collision warning reproduction model generation unit 83 may further use “time period”, “road type”, “driver information”, etc. as feature amounts when the type of the warning target object is “another vehicle”.

Pattern B shown in FIG. 5 corresponds to the case where the type of the warning target object is “pedestrian”, and corresponds to mesh M2 in the example shown in FIG. 4. When the PCS collision warning activates with “pedestrians” as the warning target object, one of the factors is presumed to be the day of the week and the time of day when there are relatively many people coming and going, such as commuting hours and school hours. In this case, the collision warning reproduction model generation unit 83 uses “weekday or holiday” and “time period” when the collision warning is activated in the target vehicle V3 as the feature amounts that affect the reproduction of the collision warning. In this way, when the warning target object is a “pedestrian”, a collision warning reproduction model can be generated by using weekdays, holidays, and time periods, which are highly correlated with human traffic, as feature amounts, thereby reliably improving the accuracy of the reproduction estimation described later. Note that the collision warning reproduction model generation unit 83 uses the “wiper ON/OFF signal”, the “headlight ON/OFF signal”, and the “driver information” as feature amounts when the type of the warning target object is “pedestrian”, etc. may be further used.

Pattern C shown in FIG. 5 is a case where the type of the warning target object is a “structure” such as a side wall, a guardrail, and a utility pole, and in the example shown in FIG. 4, mesh M3 corresponds. If the PCS warning is activated with a “structure” as the warning target object, it is presumed that the deterioration of visibility due to rainfall or sunset is a factor. In this case, the collision warning reproduction model generation unit 83 uses the “weather information” and “time zone” when the collision warning was activated in the target vehicle V4 as the feature amounts that affect the collision warning reproduction estimation. Here, the “weather information” may be obtained based on the wiper ON/OFF signal, or may be obtained directly based on the weather information. Also, the time period may be obtained from the time of day, or may be obtained based on the headlight ON/OFF signal. In this way, when the warning target object is a “structure”, a collision warning reproduction model can be generated by using the weather and time of day that are highly correlated with the visibility of the structure as feature amounts. It is possible to reliably improve the accuracy. Note that the collision warning reproduction model generation unit 83 may further use “driver information” or the like as the feature amount when the type of the warning target object is “structure”.

Pattern D shown in FIG. 5 is when the type of the warning target object does not correspond to any of “another vehicle,” “pedestrian,” or “structure,” that is, when the type of the warning target object is “unknown.” In the example shown in FIG. 4, the mesh

M4 corresponds. In this case, there is a high possibility that the collision warning for the target vehicle V5 has been activated unnecessarily, so the collision warning reproduction model generation unit 83 does not generate a collision warning reproduction model. That is, reproduction estimation, which will be described later, is not executed either. In this way, when the type of the warning target object is “unknown”, the collision warning reproduction model is not generated and the reproduction estimation is not executed, thereby suppressing unnecessary operation of the vehicle support control, which will be described later. That is, it is possible to effectively suppress the driver from being annoyed. In addition to the above three types of objects (other vehicles, pedestrians, and structures), the types of warning target objects to include motorcycles, bicycles, utility poles, signs, traffic lights, and falling objects.” can also be determined.

The collision warning reproduction model generation unit 83 stores the generated collision warning reproduction model in the auxiliary storage device 94 in association with the mesh codes of the meshes M1 to M4. In the example shown in FIG. 4, the collision warning of the PCS operates with the warning target object for “another vehicle” in the mesh M1, “pedestrian” in the mesh M2, and “structure” in the mesh M3. However, in one mesh M, multiple collision warnings may be activated for different types of warning target objects. For example, in the mesh M1, a collision warning may be activated for the target vehicle V1 with “another vehicle” as the warning target object, and a collision warning may be activated for the target vehicle V2 with the “pedestrian” as the warning target. In such a case, the collision warning reproduction model generation unit 83 may generate a plurality of collision warning reproduction models for each type of warning target object for the mesh M1. Alternatively, for the mesh M1, the collision warning reproduction model generation unit 83 generates “traffic volume”, which is the feature amount when the warning target object is “another vehicle”, and the feature amount when the warning target object is “pedestrians”. It is also possible to generate one collision warning reproduction model using quantities such as “weekday or holiday” and “time period”.

The reproduction estimation unit 84 inputs the target vehicle data of the target vehicle V that reaches or approaches the meshes M1 to M4 within a certain time into the collision warning reproduction model generated for each of the meshes M1 to M4 by the collision warning reproduction model generation unit 83. Thereby, the reproduction estimation unit 84 executes reproduction estimation to estimate whether the collision warning will be reproduced in the target vehicle V within a certain period of time. Here, the certain period of time is not particularly limited, and may be less than 5 minutes or longer than 5 minutes. Whether the target vehicle V will reach or approach the meshes M1 to M4 within a certain period of time can be estimated based on changes in the position information of the target vehicle V over time. In the present embodiment, the reproduction estimation unit 84 performs collision warning reproduction estimation using, for example, a convolutional neural network (CNN). Note that the reproduction estimation unit 84 may perform collision warning reproduction estimation using a neural network other than the convolutional neural network. Further, the reproduction estimation unit 84 may use well-known machine learning other than neural networks. Note that, when a collision warning is activated in a predetermined target vehicle V within the meshes M1 to M4, the reproduction estimation unit 84 inputs the target vehicle data of the target vehicle V for which the collision warning has been activated into the collision warning reproduction model. Therefore, it is also possible to estimate whether the collision warning will be reproduced in another target vehicle V (following vehicle group) that may pass through the position where the collision warning was activated.

When the reproduction estimation unit 84 estimates that the collision warning will be reproduced in the target vehicle V within a certain period of time, the collision warning is determined to be “reproduced”. Further, when it is estimated that the collision warning will not be reproduced in the target vehicle V within a certain period of time, the reproduction estimation unit 84 determines that the collision warning is “not reproduced”. Note that when a plurality of collision warning reproduction models are generated for one mesh M1 to M4 that the target vehicle V is expected to reach within a certain period of time, the reproduction estimation unit 84 selects the one with the closest running state of the target vehicle V. Reproduction estimation may be performed using the collision warning reproduction model. The reproduction estimation unit 84 stores the estimation result in the auxiliary storage device 94 in association with the mesh code and the vehicle ID.

When there is a target vehicle V for which the collision warning is estimated to be “reproduced” by the reproduction estimation unit 84 , the vehicle support control unit 85 selects the target vehicle V as a support target vehicle. In addition, the vehicle support control unit 85 executes support control for suppressing the occurrence of a collision of the selected support target vehicle. The vehicle support control unit 85 controls support target vehicles through the wireless communication device 92.

As support control, the vehicle support control unit 85 may alert the support target vehicle by notifying the warning activation position information, which is information about the position at which the collision warning is activated. Further, when the vehicle to be assisted is running with driving assistance such as Adaptive Cruise Control (ACC), the vehicle support control unit 85 reduces the target set speed of ACC or cancels ACC as assistance control. The driving operation may be switched to manual driving by the driver. In addition, when the support target vehicle is traveling by fully automatic driving, the vehicle support control unit 85 may detour the travel route of the support target vehicle from the collision warning activation position, or may cancel the automatic driving. .

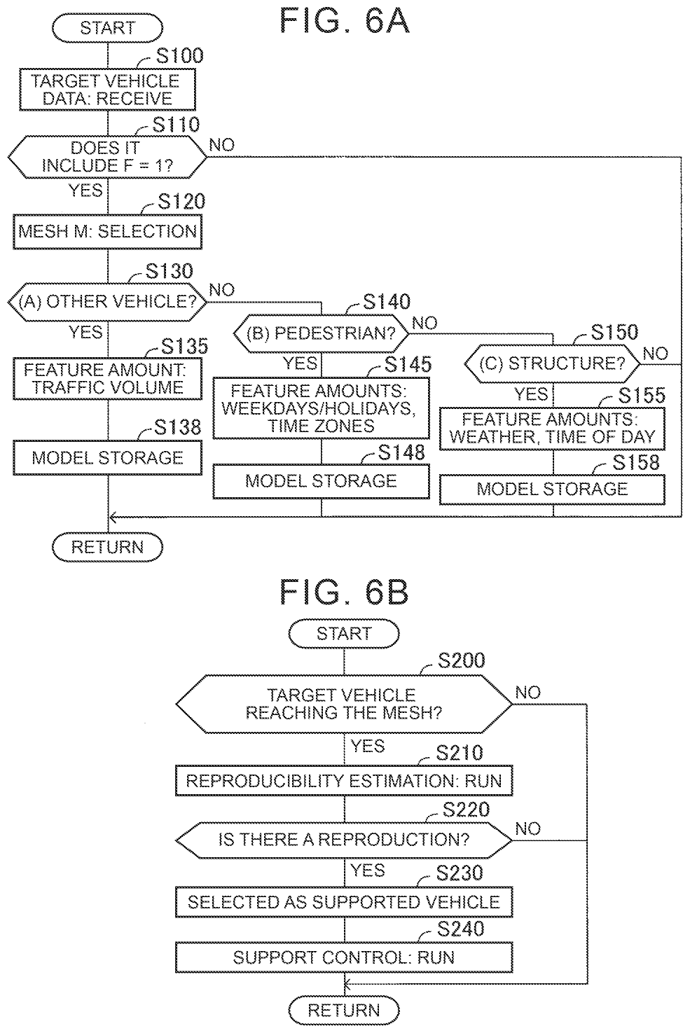

Next, a routine for generating a collision warning reproduction model will be described with reference to FIG. 6A. In addition, below, a step is simply called “S”.

In S100, the processor 81 receives target vehicle data sequentially transmitted from the target vehicle V via the network 2 and stores the data in the auxiliary storage device 94. The target vehicle data may be received, for example, at a one-minute cycle, a cycle of less than one minute, or a cycle longer than one minute. At S110, the processor 81 determines whether or not the target vehicle data received at S100 includes ON of the collision warning flag F (F=1). If the ON of the collision warning flag F is not included (No), the processor 81 returns this routine. That is, the processor 81 once terminates this routine without generating a collision warning reproduction model. On the other hand, if the collision warning flag F is ON (Yes), the processor 81 proceeds to the process of S120.

In S120, the processor 81 selects the mesh M including the position information on the map of the target vehicle V when the collision warning flag F is turned ON. Next, in S130, the processor 81 determines whether the type of the warning target object is the pattern (A) of “another vehicle”. If the type of the warning target object is not “another vehicle” (No), the processor 81 proceeds to the process of S140. On the other hand, if the type of warning target object is “another vehicle” (Yes), the processor 81 proceeds to the process of S135, and the vehicle speed v and the distance D of the target vehicle V when the collision warning flag F is turned ON. In addition, a collision warning reproduction model is generated using the “surrounding traffic volume” of the target vehicle V as a feature amount. In S138, the processor 81 associates the collision warning reproduction model generated in S135 with the mesh code of the mesh M selected in S120 and stores it in the auxiliary storage device 94. After that, the processor 81 returns this routine.

In S140, the processor 81 determines whether the type of the warning target object is pattern (B) “pedestrian”. If the type of warning target object is not “pedestrian” (No), the processor 81 proceeds to the process of S150. On the other hand, if the type of warning target object is a “pedestrian” (Yes), the processor 81 proceeds to the process of S145, and the vehicle speed v and the distance D of the target vehicle V when the collision warning flag F is turned ON. In addition, a collision warning reproduction model is generated using “weekday or holiday” and “time period” as feature amounts. In S148, the processor 81 associates the collision warning reproduction model generated in S145 with the mesh code of the mesh M selected in S120 and stores it in the auxiliary storage device 94. After that, the processor 81 returns this routine.

In S150, the processor 81 determines whether the type of the warning target object is pattern (C) “structure”. If the type of the warning target object is not “structure” (No), the processor 81 once terminates (returns) this routine without generating a collision warning reproduction model. On the other hand, if the type of warning target object is “structure” (Yes), the processor 81 proceeds to the process of S155, and the vehicle speed v and the distance D of the target vehicle V when the collision warning flag F is turned ON. In addition, a collision warning reproduction model is generated using “weather information” and “time period” as feature amounts. In S158, the processor 81 associates the collision warning reproduction model generated in S155 with the mesh code of the mesh M selected in S120 and stores it in the auxiliary storage device 94. After that, the processor 81 returns this routine.

Next, based on FIG. 6B, the collision warning reproduction estimation processing and support control processing routines will be described. It should be noted that this routine will be described on the assumption that a collision warning reproduction model has been generated for at least one or more meshes M by executing the routine shown in FIG. 6A. In S200, the processor 81 determines whether there is a target vehicle V that will reach or approach the mesh M within a certain period of time based on the received target vehicle data of the target vehicle V. If there is a target vehicle V that will reach or approach the mesh M within the fixed time (Yes), the processor 81 proceeds to the process of S210. On the other hand, if there is no target vehicle V that will reach or approach the mesh M within the fixed time (No), the processor 81 returns this routine without executing reproduction estimation.

In S210, the processor 81 inputs the target vehicle data of the target vehicle V into the collision warning reproduction model of the mesh M determined that the target vehicle V will arrive or approach within a certain period of time, thereby estimating the reproduction of the collision warning. Next, in S220, the processor 81 determines whether the estimation result of the collision warning is “reproduced”. If the estimation result is not “reproduced” (No), the processor 81 returns this routine without executing support control. On the other hand, if the estimation result is “reproduced” (Yes), the processor 81 proceeds to the process of S230. In S230, the processor 81 selects the target vehicle V for which the collision warning is estimated to be “repeated” as the support target vehicle. Next, in S240, the processor 81 executes support control such as alerting the support target vehicle. After that, the processor 81 returns this routine.

The present disclosure is not limited to the above embodiments, and various modifications are possible without departing from the purpose of the present disclosure. For example, in the flow shown in FIGS. 6A and 6B, the type of the warning target object is described as being executed in the model generation processing routine shown in FIG. 6A.

However, in the reproduction estimation processing routine shown in FIG. 6B, it is also possible to perform type determination at the timing of execution of reproduction estimation. In this case, for example, when estimating whether the collision warning will be reproduced in the following vehicle group when the collision warning is activated with the “other vehicle” as the warning target object for the preceding vehicle, the feature amount for the other vehicle is used. The reproduction estimation unit 84 in which the collision warning reproduction model is installed may be appropriately selected and utilized. In addition, in the above embodiment, the collision warning by PCS was explained as an example, but it is possible to widely apply to the reproduction estimation of other warnings such as departure warning by lane departure prevention control.

What is claimed is:

1. An information processing system configured to estimate whether activation of a collision warning in a predetermined target vehicle is reproducible in another target vehicle, the information processing system comprising:
an acquisition unit configured to acquire target vehicle data that is information on the target vehicle; and
a reproduction estimation unit configured to estimate whether the collision warning is reproducible in the other target vehicle by inputting the target vehicle data acquired by the acquisition unit to a collision warning reproduction model generated by extracting a predetermined feature amount that contributes to reproduction of the collision warning from the target vehicle data of the predetermined target vehicle.

2. The information processing system according to claim 1, further comprising a type determination unit configured to determine a type of a warning target object of the collision warning activated in the predetermined target vehicle, wherein the reproduction estimation unit is configured to change the feature amount based on the type of the warning target object determined by the type determination unit.

3. The information processing system according to claim 2, wherein:
the acquisition unit is configured to acquire a traffic volume around the target vehicle as the target vehicle data; and
the reproduction estimation unit is configured to use at least the traffic volume for the feature amount when the type determination unit determines that the type of the warning target object is another vehicle.

4. The information processing system according to claim 2, wherein:
the acquisition unit is configured to acquire discrimination between a weekday and a holiday as the target vehicle data; and
the reproduction estimation unit is configured to use at least the discrimination between the weekday and the holiday for the feature amount when the type determination unit determines that the type of the warning target object is a pedestrian.

5. The information processing system according to claim 2, wherein:
the acquisition unit is configured to acquire weather information around the target vehicle as the target vehicle data; and
the reproduction estimation unit is configured to use at least the weather information for the feature amount when the type determination unit determines that the type of the warning target object is a structure.
